(19) United States
(12) Patent Application Publication
(10) Pub. No.: US 2004/0015545 A1
(43) Pub. Date: Jan. 22, 2004

(54) Operation system of exhibition site for internet

(76) Inventor: So-Young Lee, Goyang-city (KR)

Correspondence Address: BAKER BOTTS L.L.P., 2001 ROSS AVENUE, SUITE 600, DALLAS, TX, 75201-2980, US

(21) Appl. No.: 10/432,738

(22) PCT Filed: Nov. 22, 2001
(86) PCT No.: PCT/KR01/02019

(30) Foreign Application Priority Data
Nov. 23, 2000 (KR) 2000/70025

(51) Int. Cl. G06F 15/16

(52) U.S. Cl. 709/203; 709/219

(57) ABSTRACT

An operation system of exhibition site for Internet includes one or more computers, and one or more server computers. The personal computers and the server computers are connected to each other. The operation system collects informational contents for the goods of sale from one or more merchants, and classifies and stores the collected informational contents. Furthermore, the operation system collects informational contents for the fields of interest from one or more consumers, and classifies and stores the collected informational contents. The operation system operates an exhibition site where the stored informational contents are exhibited with a predetermined format. The operation system writes the purchase requests from the consumers in the form of a profiled, and stores the profile. The operation system mediates between the merchants and the consumers based on the profiles. In this way, the consumers can easily contact the required goods information, and the occasionally altered informational contents can be immediately transmitted to the interested consumers.

### BACKGROUND OF THE INVENTION

(a) Field of the Invention

The present invention relates to an operation system of exhibition site for Internet where informational contents for goods of sale are collected from merchants, groups of merchants or merchant companies intended to provide information for the goods of sale or the goods under development (hereinafter referred to as the “merchants”), and informational contents for fields of interest are collected from consumers, groups of consumers or consumer companies intended to obtain information for the goods of sale or the developmental trends of the goods of interest (hereinafter referred to as the “consumers”) such that the informational contents can be given to the relevant consumers or merchants in a suitable manner while displaying the informational contents at the initial screen based on user profiles.

(b) Description of the Related Art

Generally, in order to widely advertise the goods of sale of a merchant to possible consumers or interested persons, the merchant should participate in an exhibition or hold such an exhibition for himself. Alternatively, with the extensive use of computers and communication networks, the target items may be exhibited at the Internet homepage.

With the Internet-based exhibition, the merchant may operate a booth in the Internet shopping mal, or become a member of search sites such that the interested consumers can visit his homepage through the search sites.

In the meantime, the consumers visit exhibitions or Internet sites to obtain the required information for the goods of interest.

With the display of goods of sale in the exhibitions at the merchants, it involves much time and cost. Wide exhibition space should be first given, and the items to be exhibited should be delivered to the exhibition space by many workers at much cost. Furthermore, promotion brochures for the items should be prepared.

The situation is like with the side of the consumers. The consumers should go to the place of exhibitions while consuming much time and expense. Furthermore, the consumers should attentively check the required information for the goods of interest considering that they are liable to miss the details of the information later.

Furthermore, in the case of the offline exhibitions, the goods to be newly made after the exhibition period should wait for the next exhibition to be sold or introduced to the interested consumers.

In the case of the online exhibitions, a large amount of money is consumed to advertise the existence of sites to many possible consumers. As many similar sites are coexistent, the consumers cannot compare the details of the sites in a precise manner. Furthermore, as the consumers cannot memorize or bookmark all the sites, they should again make access to the relevant sites or search for the relevant sites at needs.

In the case of the exhibitions based on the Internet shopping mal, it is difficult to give and collect technical information for the developmental trends or concepts for the target items.

With the use of search sites, the information to be addressed is largely differentiated depending upon the search techniques. As the search sites are structured in a widely different manner, great confusion may prevail for the consumers. If too many similar sites are checked, it becomes impossible to make access to the sites one by one.

In sum, with the existent exhibition techniques, the merchants as well as the consumers should involve much time and cost in making the required information exchange.

### SUMMARY OF THE INVENTION

It is an object of the present invention to provide an operation system of exhibition site for Internet which can make the information exchange in an effective manner.

This and other objects may be achieved by the operation system of exhibition site for Internet with the following features.

The operation system includes one or more personal computers, and one or more server computers connected to the personal computers. The operation system collects informational contents of goods from one or more merchants while classifying and storing the informational contents, collects informational contents of fields of interest from one or more consumers while classifying and storing the informational contents, and operates an exhibition site for displaying the informational contents in a predetermined format. Purchase requests for the items of interest from the consumers are written in the form of a profile and stored, and the information exchange between the consumers and the merchants is made based on the profiles.

Electronic mail addresses of the merchants and electronic mail addresses of the consumers are stored at the profiles.

In case the merchant gives a new informational content or alters the stored informational content, electronic mails of informing such a fact are automatically sent to the registered consumers in the relevant field of interest.

In case the merchant gives a new informational content or alters the stored informational content, the newly introduced or altered informational content is stored at the profile of the consumers in the relevant field of interest, and displayed at an information window with the logging in.

In case the consumer requests the goods information while designating the field of interest or the items of interest, the request of the consumer is transmitted to the relevant merchants via electronic mail, and the goods information from the merchants is transmitted to the consumer via electronic mail.

The display contents of the initial screen are determined depending upon the fields of interest stored at the profile of the relevant consumers.

The initial screen is displayed with the logging in of the consumer while being linked to the relevant page of the sites of interest stored at the profile.

In the operation system, public competitive bids are made through the steps of requesting estimates of the items to be purchased at the consumer, sending electronic mails of informing the estimate request of the consumer to the relevant merchants, sending the estimates to the server before the predetermined time at the merchants in a secret manner, and publicizing the received estimates at the server on the predetermined time, or sending the estimates to the estimate-requesting consumer and to the applied merchants.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or the similar components, wherein:

FIG. 1 is a block diagram of an operation system of exhibition site for Internet according to a preferred embodiment of the present invention;

FIG. 2 is a block diagram schematically illustrating the network structure of the operation system shown in FIG. 1;

FIG. 3 illustrates the contents stored at the consumer profile in the operation system shown in FIG. 1;

FIG. 4 illustrates the contents of the “default.htm” for the initial screen basically given in the operation system shown in FIG. 1;

FIG. 5 illustrates the contents of the “ID.htm” for the initial screen defined by the consumer in the operation system shown in FIG. 1;

FIG. 6 illustrates a file structure established such that with the logging-in of the consumer, the initial screen is displayed with the contents defined by the consumer using JavaScript;

FIG. 7 is a flowchart illustrating the process of displaying the initial screen defined by the consumer in the operation system shown in FIG. 1;

FIG. 8 is a flowchart illustrating the process of displaying the initial screen with the direct address designated by the consumer in the operation system shown in FIG. 1;

FIG. 9 is a flowchart illustrating the process of informing the altered goods information of the merchant to the consumer in the operation system shown in FIG. 1;

FIG. 10 is a flowchart illustrating the process of sending an electronic mail bearing the altered goods information of the merchant to the consumer in the operation system shown in FIG. 1;

FIG. 11 illustrates a consumer electronic mail address book in the operation system shown in FIG. 1;

FIG. 12 is a flowchart illustrating the process of informing the newly altered or introduced goods information to the consumer in the operation system shown in FIG. 1;

FIG. 13 is a flowchart illustrating the process of sending an electronic mail bearing the purchase request of the consumer to the relevant merchant in the operation system shown in FIG. 1;

FIG. 14 illustrates a merchant electronic mail address book in the operation system shown in FIG. 1; and

FIG. 15 is a flowchart illustrating the process of calling for public competitive bids in the operation system shown in FIG. 1.

### DETAILED DESCRIPTION OF THE PREFERRED EMBODIMENTS

Preferred embodiments of this invention will be explained with reference to the accompanying drawings.

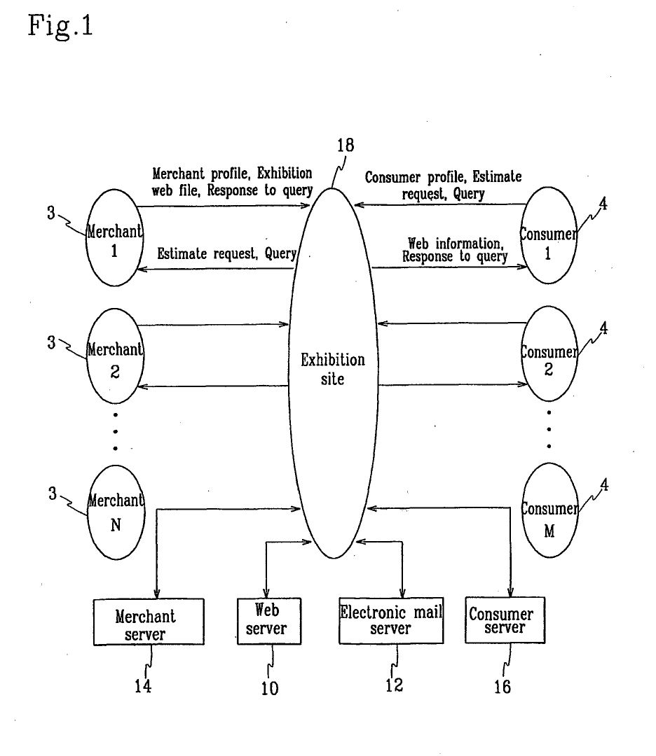

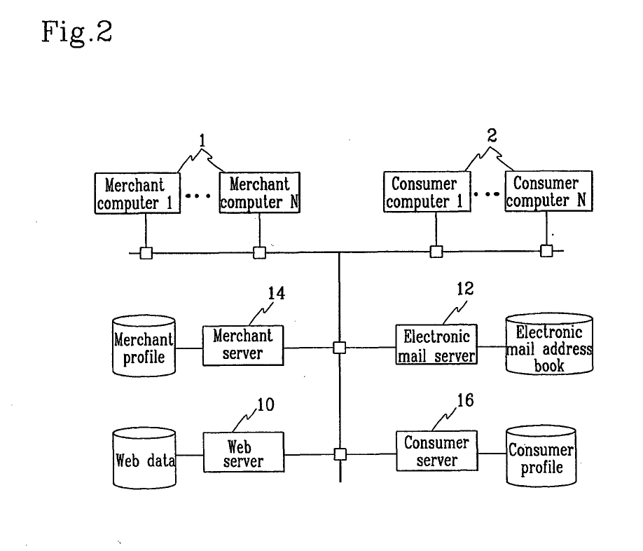

As shown in FIGS. 1 and 2, the operation system of exhibition site for Internet includes one or more personal computers 1 and 2, and one or more server computers 10, 12, 14 and 16. The personal computers and the server computers are connected to each other. The operation system collects informational contents for the goods of sale from one or more merchants 3, and classifies and stores the collected informational contents. Furthermore, the operation system collects informational contents for the fields of interest from one or more consumers 4, and classifies and stores the collected informational contents. The operation system operates an exhibition site 18 where the stored informational contents are exhibited with a predetermined format. The operation system writes the purchase requests from the consumers 4 in the form of profile, and stores the profiles. The operation system mediates between the merchants 3 and the consumers 4 based on the profiles.

The merchants 3 give the informational contents for the goods of sale through the merchant computers 1, and the consumers 4 also give, the informational contents for the fields of interest through the consumer computers 2.

The informational contents for the goods of sale and for the fields of interest are stored and managed at the merchant server 14, and the consumer server 16, respectively.

Occasionally, the merchants 3 may become to be consumers, and the consumers 4 to be merchants.

Therefore, it is possible that the merchant server 14 and the consumer server 16 may be installed either in a unified manner or in a separate manner.

The network connection of the merchant computers 1, the consumer computers 2, and the servers 10, 12, 14 and 16 may be made using TCP/IP, LAN, ADSL, VDSL, wireless area network (WAN), etc.

The consumer 4 makes access to the exhibition site 18 using the consumer computer 2, and inputs information related to the ID, password, electronic mail address, fields of interest, and desired items while making an application for membership. The consumer server 16 writes the input information in the form of a profile, and stores the profile.

The consumer 4 may make access to the exhibition site 18 from time to time, and change the consumer profile.

The consumer profile is managed using the ID and password of the consumer 4.

It is possible that the consumer profile is stored at the consumer computers 2 of the respective consumers 4, not at the consumer server 16. That is, the consumer profiles may be stored at the consumer computers 2, and called upon from the consumer computers 2 to the web server 10 or the consumer server 16 at needs.

Furthermore, it is also possible that the consumer profiles are transmitted from the consumer computers 2 to the web server 10 or the consumer server 16 to conduct the required works.

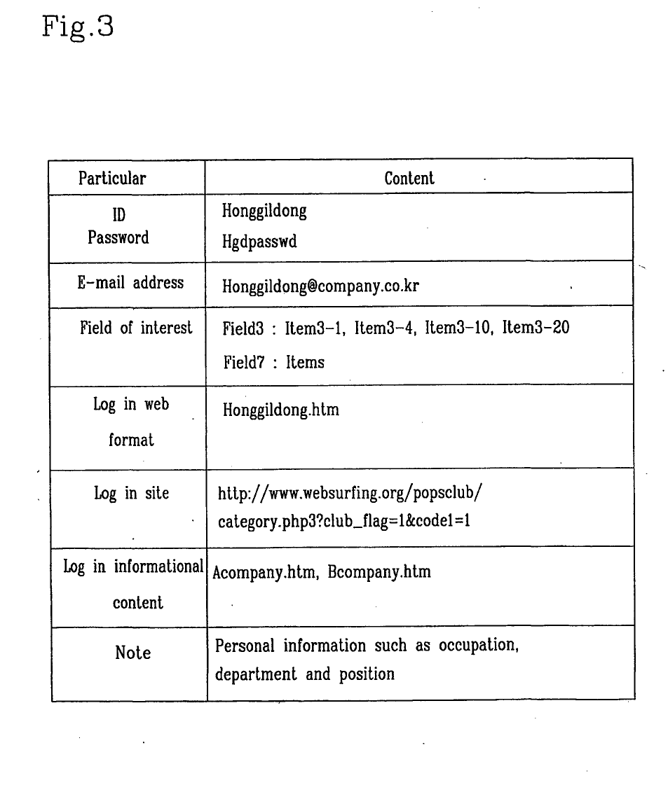

FIG. 3 illustrates the contents of such a consumer profile.

As shown in FIG. 3, the consumer profile includes the particulars of the consumer 4 such as ID, password, electronic mail address, fields of interest, log in web page, log in link site, log in notice content, position, department, and status.

The fields of interest of the consumer 4 are input in a code form depending upon the hierarchical structure adapted to the exhibition site 18.

With the input of the information on the fields of interest, those related thereto are statistically analyzed, and the analysis result is given as a basic default value such that the consumer 4 can easily write the consumer profile.

Furthermore, with the input of the information on the job, position or department, the average value thereof in the registered consumers 4 (obtained through statistical analysis) is given as a reference value such that the consumer 4 can complete the consumer profile in a rapid manner.

As shown in FIG. 3, the consumer profile includes a web page file name with the ID of the consumer for the web page to be displayed at the initial screen.

That is, the web page files to be displayed at the initial screen are written such that the initial screen is differentiated per the respective consumers 4 logged in to the exhibition site 18.

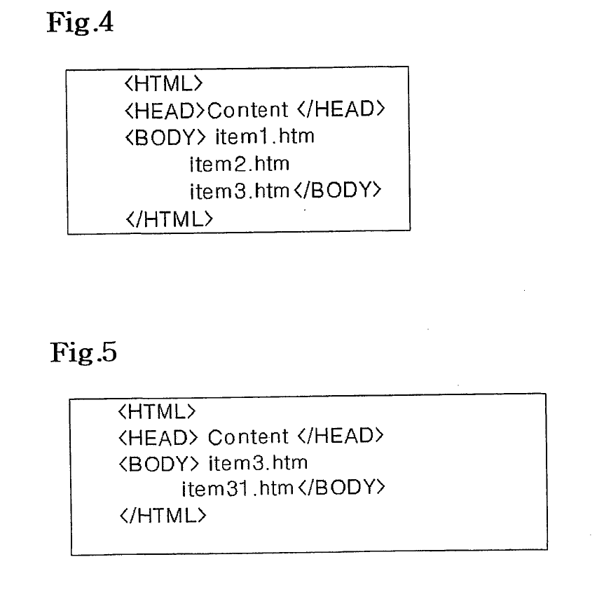

FIGS. 4 and 5 illustrate the structure of such a web page file.

When the web page file shown in FIG. 4 is basically given, several contents such as “item1.htm,” “item2.htm,” “item3.htm,” etc. are displayed at the initial screen with the logging in.

As shown in FIG. 5, when the consumer 4 is interested only in the main content of “item3.htm” and the subsidiary content of “item31.htm,” the contents to be displayed may be modified accordingly, and stored as the “ID.htm”.

In such a case, with the subsequent logging in, the “ID.htm” file defined by the consumer 4, not the basically given web page file, is called upon, and displayed at the initial screen.

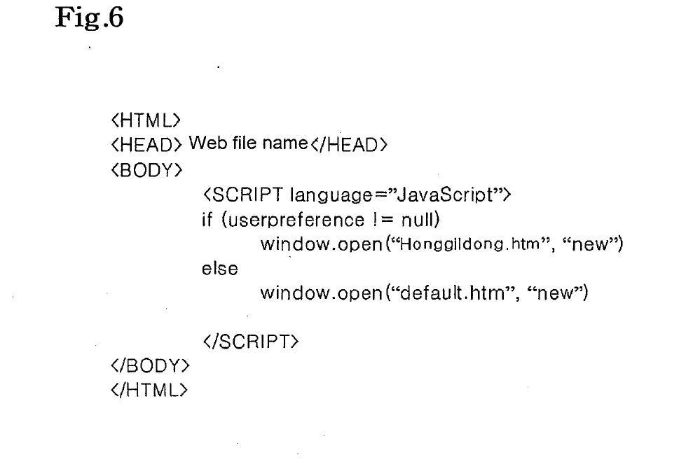

As shown in FIG. 6, the work related to the web page file to be displayed at the initial screen can be conducted through constructing an HTML structure using JavaScript.

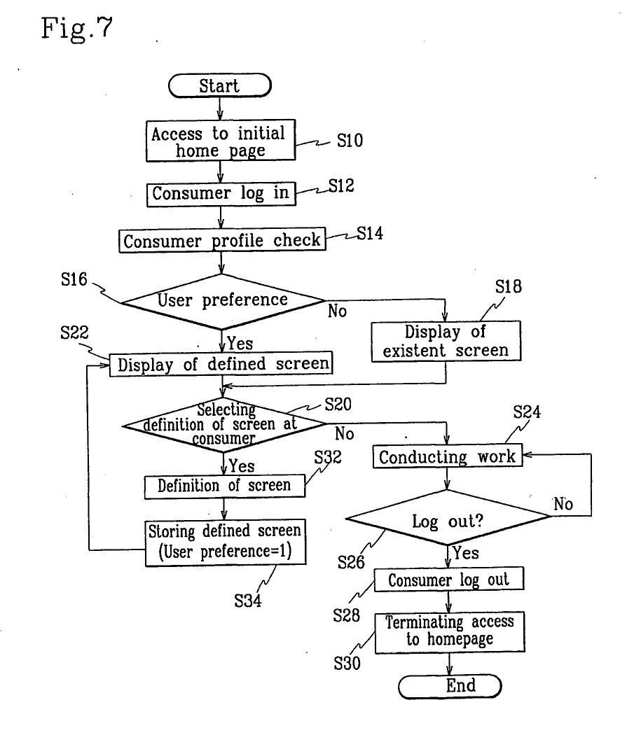

FIG. 7 is a flowchart illustrating the process of displaying the “ID.htm” file defined by the consumer 4 at the initial screen with the logging in.

First, the consumer 4 makes access to the homepage of the exhibition site 18 through driving the Internet browser (S10). The consumer 4 logs in to the exhibition site 18 by giving ID and password (S12). The profile of the consumer 4 is checked, and examined (S14). It is judged whether the profile of the consumer 4 bears a value of user preference (S16). A basic web page is displayed if the value of user preference is absent at the S16 step (S18). It is judged whether the consumer 4 selects the definition of the initial screen (S20). The works of searching, etc. are conducted pursuant to the commands of the consumer 4 if the consumer 4 does not select the definition of the initial screen at the S20 step (S24). It is judged whether the consumer 4 inputs the command of logging out (S26). The works pursuant to the commands of the consumer 4 are conducted if the command of logging out is not input at the S26 step. When the command of logging out is input, the logging out of the consumer 4 is conducted. Finally, the access to the exhibition site 18 is terminated (S30).

When the value of user preference is present at the S16 step, the “ID.htm” defined by the consumer 4 is called upon, and displayed at the initial screen while being followed by the S20 step (S22).

When the consumer 4 selects the definition of the initial screen at the S20 step, the work of defining the initial screen is conducted (S32). The initial screen defined at the S32 step is stored as “ID.htm,” and the value of user preference is defined to be 1 (S34).

The S14 step may be performed through finding the consumer profile at the consumer server 16, reading up on the profile stored at the consumer terminal 2, or receiving the profile from the consumer terminal 2 at the consumer server 16 and/or the web server 10 via network.

Furthermore, it is also possible that when the consumer 4 selects the definition of the initial screen at the S24 step, the S20 step or the S32 step is followed by.

As shown in FIG. 3, the consumer profile contains link sites such that the sites are linked and displayed at the initial screen with the logging in.

That is, the link sites of interest are linked and displayed at the initial screen so that the consumer 4 can directly make access to those sites with the logging in to the exhibition site 18.

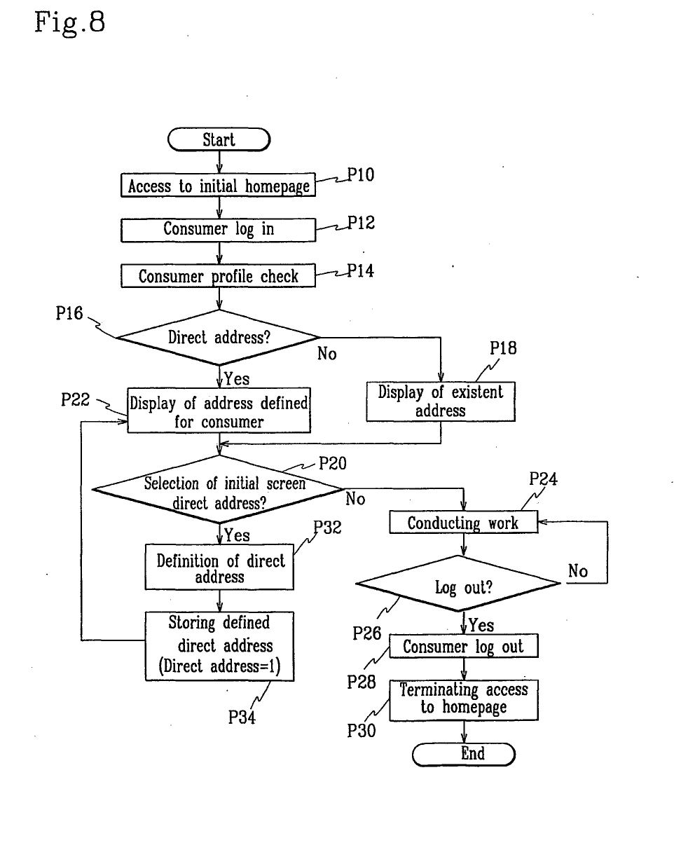

FIG. 8 is a flowchart illustrating the process of linking the sites of interest and displaying those sites at the initial screen with the logging in.

First, the consumer 4 makes access to the homepage of the exhibition site 18 through driving the Internet browser (P10). The consumer 4 logs in to the exhibition site 18 by giving ID and password (P12). The profile of the logged-in consumer 4 is checked, and examined (P14). It is judged whether the address of the site to which the consumer 4 makes direct access (referred to hereinafter as the “direct address”) is present in the profile of the consumer 4 (P16). In case the direct address is absent at the P16 step, the basic address is displayed at the initial screen (P18). It is judged whether the consumer 4 inputs the command of writing or editing the direct address with the logging in (P20). In case the consumer 4 does not select the definition of the direct address at the P20 step, the works of searching, etc. are conducted pursuant to the commands input by the consumer 4 (P24). It is judged whether the consumer 4 inputs the command of logging out (P26). If the command of logging out is not input at the P26 step, the subsequently input commands are executed. When the command of logging out is input, the logging out of the consumer 4 is conducted (P28). Finally, the access to the exhibition site 18 is terminated (P30).

In case the direct address is present at the P16 step, the direct address defined by the consumer 4 is displayed at the initial screen, and followed by the P20 step (P22).

In case the consumer 4 selects the definition of the direct address at the P20 step, the work of defining the direct address is conducted (P32). The direct address defined at the P32 step is stored, and the value of the direct address is defined to be 1 (P34).

When the profile of the consumer 4 is structured in the above way, the consumer can directly move to the site of interest in a convenient manner.

As with the S14 step, the P14 step may be performed through finding the consumer profile at the consumer server 16, reading up on the profile stored at the consumer terminal 2, or receiving the profile from the consumer terminal 2 at the consumer server 16 and/or the web server 10 via network.

Furthermore, it is also possible that when the consumer 4 selects the definition of the initial screen at the P24 step, the P20 step or the P32 step is followed by.

As with the consumer 4, the merchant 3 makes access to the exhibition site 18 using the merchant computer 1, and inputs information related to the ID, password, electronic mail address, homepage address, and items to be exhibited while making an application for membership. The merchant server 14 writes the input information in the form of a merchant profile, and stores the profile.

The informational contents input by the merchant 3 are classified in a hierarchical manner, and stored as web data by the web server 10 operating the exhibition site 18.

The merchant 3 may make access to the exhibition site 18 from time to time, and change the merchant profile, and the web data.

The web data written by the merchant 3 are structured in the form of web file such as HTML, CSS and JavaScript, and the down files are structured in the form of text file or web file.

As with the consumer profile, the merchant profile is stored at the merchant computer 1 of each merchant 3, not at the consumer server 14.

That is, the merchant profile may be stored at the merchant computer 1, and called upon from the merchant computer 1 to the web server 10 or the merchant server 14 at needs.

Furthermore, the merchant profile may be transmitted from the merchant computer 1 to the web server 10 or the merchant server 14 via network, thereby conducting the required works.

As shown in FIGS. 1 and 2, the operation system of exhibition site for Internet further includes an electronic mail server 12 storing the electronic mail addresses of the consumers 4 and the merchants 3, and giving the information required for the consumers 4 and/or the merchants 3 via electronic mail.

The web server 10, the electronic mail server 12, the merchant server 14 and the consumer server 16 are installed and managed in a separate manner. It is possible to incorporate the respective servers into one body. If needed, additional servers may be further provided.

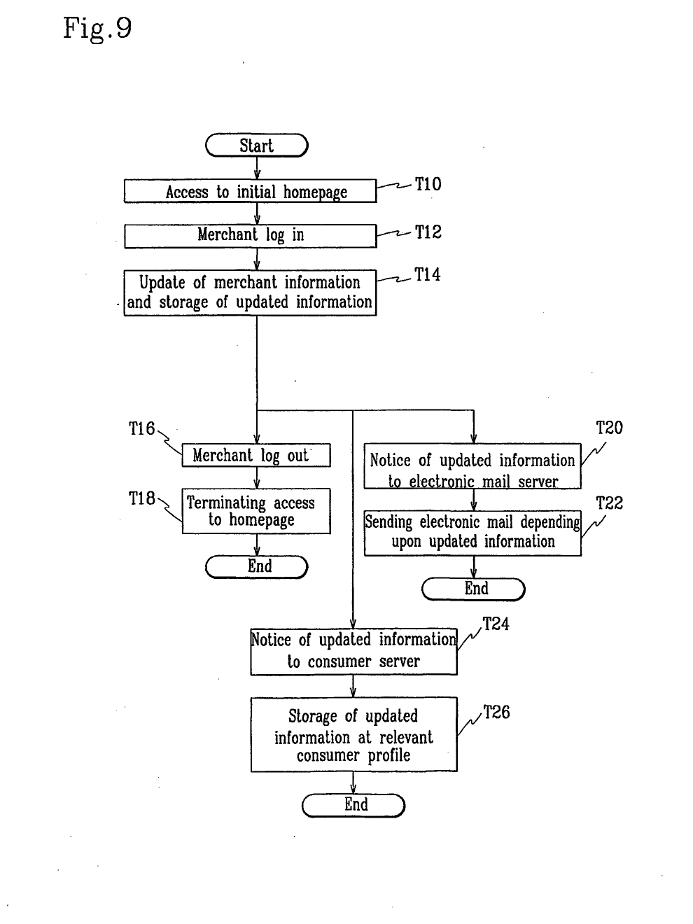

FIG. 9 is a flowchart illustrating the process of sending electronic mails bearing a newly introduced or altered goods information to the interested consumers 4 or storing the information at the consumer profiles when the merchant 3 newly inputs a goods information, or alters the existent goods information.

First, the merchant 3 makes access to the homepage of the exhibition site 18 through driving the Internet browser (T10). The merchant 3 logs in to the exhibition site 18 by giving ID and password (T12). The merchant 3 updates the web data related to the goods information, and stores them at the merchant server 14 (T14). When the merchant 3 completing the update of the goods information inputs the command of logging out, the logging out of the merchant 3 is conducted (T16). Finally, the access to the exhibition site 18 is terminated (T18).

The altered web data of the merchant 3 at the T14 step is checked at the merchant server 14 and/or the web server 10, and transmitted to the electronic mail server 12 (T20). The electronic mail server 12 sends electronic mails bearing the updated information to the interested consumers 4 (T22).

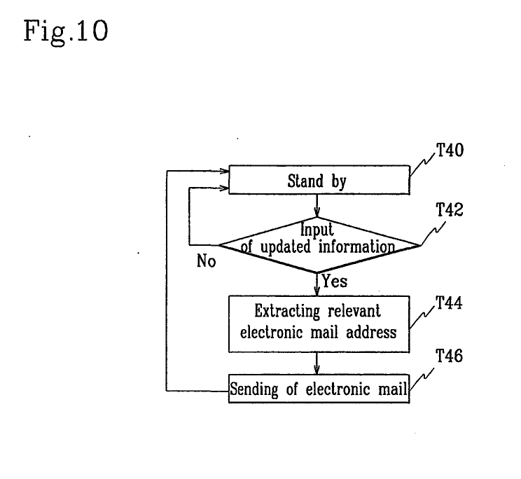

The sending of the electronic mails by the web server 10 and the electronic mail server 12 is made through the steps illustrated in FIG. 10.

First, a signal to the effect that the goods information of the merchant 3 is altered is input at a stand-by state T40 (T42). The electronic mail address book of the relevant consumers 4 is checked (T44). Electronic mails are sent to the relevant consumers 4 while informing that the goods information is altered, or a goods information is newly introduced (T46).

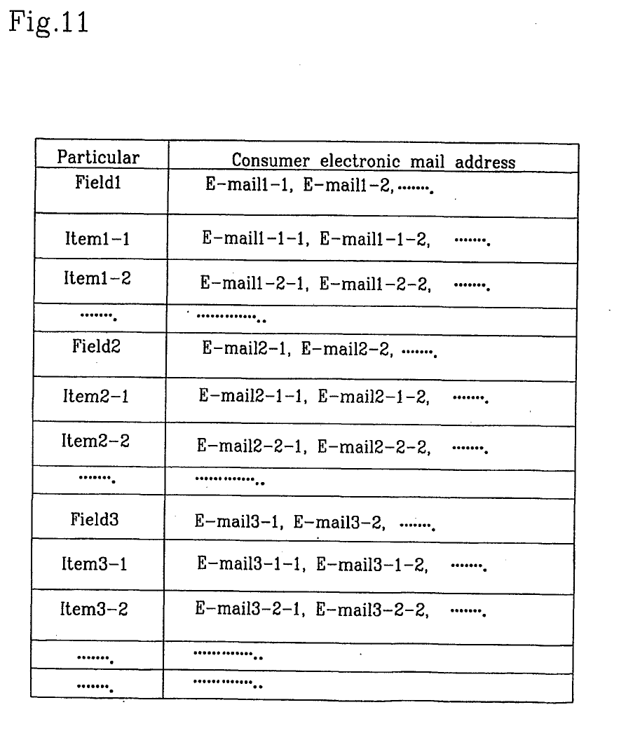

It is preferable that the electronic mail address book of the consumer 4 stored at the e-mail server 12 is structured as illustrated in FIG. 11.

As shown in FIG. 11, the e-mail addresses of the consumers 4 who have common interests per the field and kind of goods are collected, and managed in a unified manner.

The altered web data of the merchant 3 at the T14 step are checked at the merchant server 14 and/or at the web server 10, and transmitted to the consumer server 16 (T24). The consumer server 16 stores the altered goods information at the profiles of the interested consumers 4 (T26).

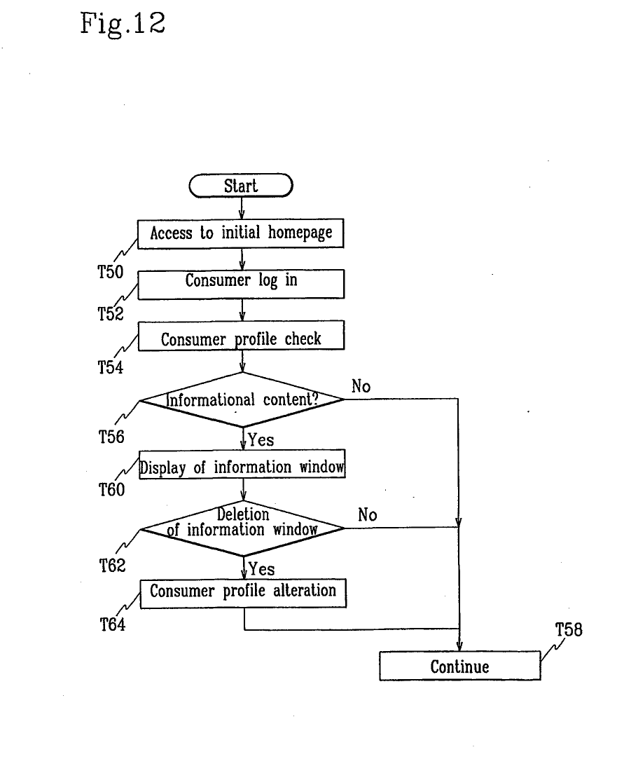

That is, the web server 10 and the consumer server 16 inform the alteration of the goods information to the consumers 4 through the steps illustrated in FIG. 12.

First, the consumer 4 makes access to the homepage of the exhibition site 18 through driving the Internet browser (T50). The consumer 4 logs in to the exhibition site 18 by giving ID and password (T52). The profile of the logged-in consumer 4 is checked, and examined (T54). It is judged whether the profile of the consumer 4 involves a new goods information or an altered goods information (T56). In case such an informational content is absent in the profile of the consumer 4 at the T56 step, other normal works are conducted (T58). If any new or altered informational content is present at the T56 step, it is displayed at the initial screen with an information window (T60). It is judged whether the consumer 4 inputs the command of deleting the information window (T62). If the command of deletion is not input at the T62 step, it is followed by the T58 step. By contrast, if the command of deletion is input at the T62 step, the profile of the consumer 4 is altered and stored, and it is followed by the T58 step (T64).

In case plural numbers of information widows are present at the T62 step, it is possible for the consumer 4 to select some of the information windows and delete them, or to delete all of the information windows.

As with the S14 step and the P14 step, the T54 step may be performed through finding the consumer profile at the consumer server 16, reading up on the profile stored at the consumer terminal 2, or receiving the profile from the consumer terminal 2 at the consumer server 16 and/or the web server 10 via network.

In the operation system of exhibition site for Internet, when the consumer 4 intends to search for the information on the items of interest while not knowing the merchants of the items, or to receive estimates of the items, electronic mails are sent to the relevant merchants 3 such that the consumer 4 can receive the information on the interested items or the estimates thereof.

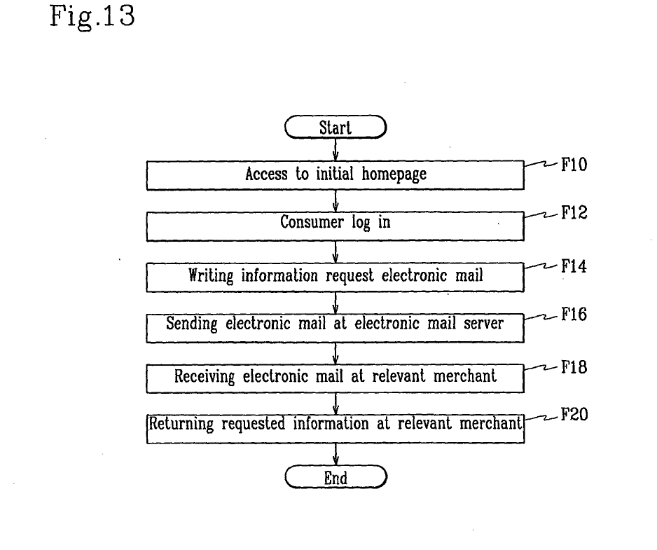

That is, as shown in FIG. 13, the consumer 4 makes access to the homepage of the exhibition site 18 through driving the Internet browser (F10). The consumer 4 logs in to the exhibition site 18 by giving ID and password (F12). An electronic mail is written to request the information on the items of interest or the estimates thereof (F14). The written electronic mail is sent to the webserver 10 (F16). The web server 10 and the electronic mail server 16 check the electronic mail addresses of the relevant merchants 3 at the merchant address book stored at the electronic mail server 16, and send electronic mails to the merchants 3 (F18). The merchants 3 return the information on the relevant items, and the estimates thereof (F20).

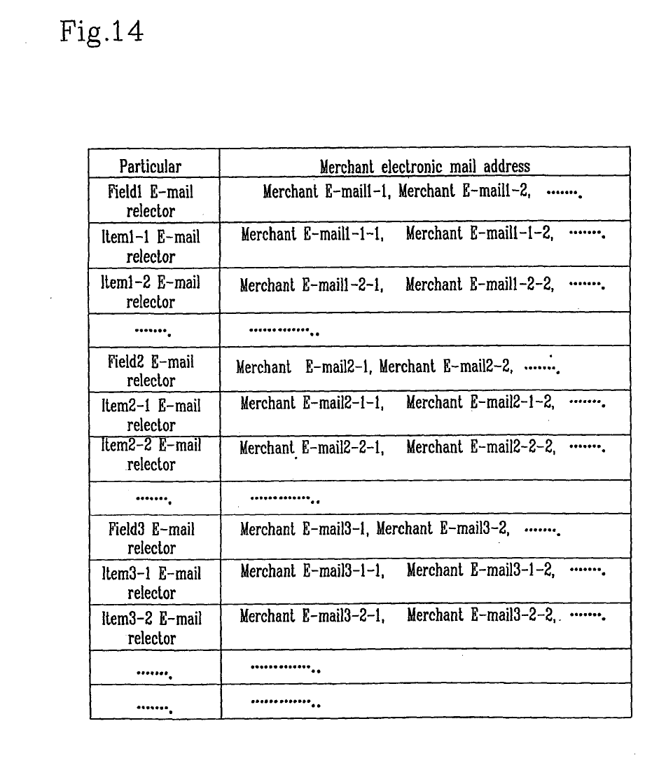

It is preferable that the electronic mail address book of the merchants 3 stored at the electronic mail server 12 is structured as illustrated in FIG. 14.

As shown in FIG. 14, the electronic mail address book of the merchants 3 is structured such that the electronic mail addresses of the merchants 3 are collected per the field and kind of goods, and managed in a unified manner.

As the electronic mails are sent according to the fields and kinds of goods, they are transmitted to the electronic mail relector of the relevant field or kind, and those transmitted to the electronic mail relector are automatically sent to the electronic mail addresses of all the registered merchants 4.

Furthermore, in the operation system of exhibition site for Internet, when the consumer 4 intends to purchase the required items through competitive bids, the intention of the consumer 4 is informed to the relevant merchants 3. The merchants 3 submit the estimates of the target items in a secret manner, and the submitted estimates are publicized directly after the time appointed for the bidding to thereby make a successful bid.

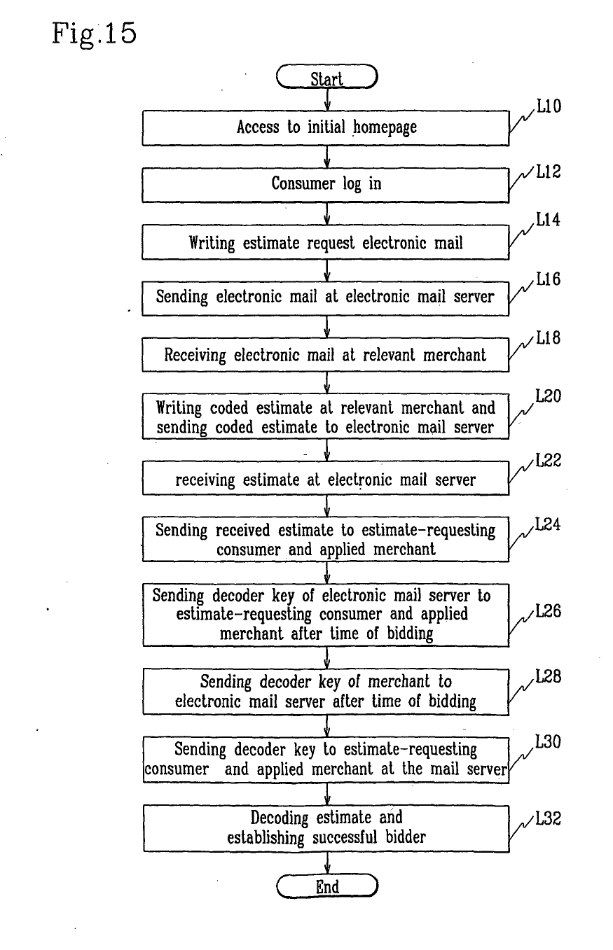

That is, as shown in FIG. 15, the consumer 4 makes access to the homepage of the exhibition site 18 through driving the Internet browser (L10). The consumer 4 logs in to the exhibition site 18 by giving ID and password (L12). The consumer 4 writes an electronic mail of requesting the estimates of the desired items, and sends it to the web server 10 (L14). The web server 10 and the electronic mail server 16 send electronic mails for requesting the estimates to the relevant merchants 3 (L16). The merchants 4 receive the electronic mails (L18). The interested merchant 4 write an estimate in a code form, and send it to the web server 10 and/or the electronic mail server 16 (L20). The electronic mail server 16 receives the estimates, and stores them (L22). The electronic mail server 16 sends the estimates to the purchase-requesting consumer 4 and to the applied merchants 3 (L24). After the time appointed for the bidding passes by, the decoder key of the electronic mail server 16 is sent to the purchase-requesting consumer 4 and the applied merchants 3 (L26). After the time appointed for the bidding passes by, the merchants 3 send a decoder key to the electronic mail server (L28). The electronic mail server 16 sends the decoder key of the respective merchants 3 to the purchase-requesting consumer 4 and to the applied merchants 3 (L30). The estimates are decoded, and a successful bidder is established (L32).

In the above process, it is possible that the bids for the target items are made with respect to many and unspecified persons, thereby purchasing the desired items in a public manner.

The goods information may include various kinds of information for the specific fields such as information for the goods, news, weathers, sports, entertainments, economics, sciences, papers, patents, etc.

Furthermore, in addition to the exhibition site, the above structure may be applied to a community site, a portal site, a shopping mal site, a matchmaking site, and a search site.

In addition, the distinction between the consumer and the merchant is made only for the explanatory purpose. That is, the terms of the consumer and the merchant can be interchangeably used. Furthermore, the operator of the exhibition site may be the merchant.

As described above, in the inventive operation system of exhibition site for Internet, when the consumers log in to the system, the informational contents required for the consumers are displayed at the initial screen, thereby simplifying the searching steps.

Furthermore, as the merchants can easily exhibit the altered information of goods, the new information of goods and the information of goods to be developed, advertisements for the intended items can be frequently made at needs, and the goods information can be transmitted to the relevant consumers in an effective manner.

As the sites and the goods information once found by the consumers are stored in the form of profile, the access to the sites and the information can be easily made compared to the process of searching by way of repeated book markings.

As the consumers or the merchants can receive the required electronic mails from time to time, the correspondence is easily made, and the efficiency of use for the relevant information is maximized.

As the public competitive bids can be made, the consumers can purchase the desired high-quality items at low cost.

As the site is operated as an exclusive site for exhibiting the goods information, the persons who need only the goods information mainly use the site, and the information exchange between the consumers and the merchants can be made in a satisfactory manner.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. An operation system of exhibition site for Internet comprising one or more personal computers, and one or more server computers connected to the personal computers, the operation system collecting informational contents of goods from one or more merchants while classifying and storing the informational contents, collecting informational contents of fields of interest from one or more consumers while classifying and storing the informational contents, and operating an exhibition site for displaying the informational contents in a predetermined format, purchase requests for the items of interest from the consumers being written in the form of a profile and stored, and the information exchange between the consumers and the merchants being made based on the profiles.

2. The operation system of claim 1 wherein electronic mail addresses of the merchants and electronic mail addresses of the consumers are stored at the profiles.

3. The operation system of claim 1 wherein in case the merchant gives a new informational content or alters the stored informational content, electronic mails of informing such a fact are automatically sent to the registered consumers in the relevant field of interest.

4. The operation system of claim 3 wherein in case the merchant gives a new informational content or alters the stored informational content, the process of informing such a fact to the consumers comprising the steps of:
making access to the homepage of the exhibition site through driving the Internet browser at the merchant;
logging in to the exhibition site by giving ID and password at the merchant;
updating the web data related to the goods information of the merchant and storing the updated data in the server at the merchant;
conducting the logging out of the merchant when the merchant completes the updating of the goods information and inputs the command of logging out;
terminating the access to the exhibition site; and
checking the altered web data of the merchant at the server, extracting the relevant consumers from the electronic mail address book of the consumers, and sending electronic mails of informing the alteration of the web data of the merchant to the relevant consumers.

5. The operation system of claim 1 wherein in case the merchant gives a new informational content or alters the stored informational content, the newly introduced or altered informational content is stored at the profile of the consumers in the relevant field of interest, and displayed at an information window with the logging in.

6. The operation system of claim 5 wherein the process of displaying the newly introduced or altered informational content at the information window comprising the steps of:
making access to the homepage of the exhibition site through driving the Internet browser at the consumers;
logging in to the exhibition site at the consumer by giving ID and password;
checking and examining the profile of the logged-in consumer;
judging from the profile of the logged-in consumer whether the newly introduced or altered informational content is noticed to the consumer;
conducting other normal works if it is not necessary to notice the newly introduced or altered informational content to the consumer;
displaying the newly introduced or altered informational content at the information window if it is necessary to notice the newly introduced or altered informational content to the consumer;
judging whether the consumer inputs the command of deleting the information window; and
either conducting other normal works if the command of deleting the information window is not input, or altering the profile of the consumer if the command of deleting the information window is input while being followed by the step of conducting other normal works.

7. The operation system of claim 1 wherein in case the consumer requests the goods information while designating the field of interest or the items of interest but not designating the merchant, the request of the consumer is transmitted to the relevant merchants via electronic mail, and the goods information from the merchants is transmitted to the consumer via electronic mail.

8. The operation system of claim 7 wherein the process of transmitting the goods information to the consumer comprising the steps of:
making access to the homepage of the exhibition site through driving the Internet browser at the consumer;
logging in to the exhibition site at the consumer by giving ID and password;
writing an electronic mail of requesting the goods information at the consumer;
sending the electronic mail to the server;
extracting the relevant merchants from the electronic mail address book of the merchants, and sending electronic mails of informing the request of the consumer to the relevant merchants at the server; and
returning the goods information for the designated items and the estimates of the designated items to the server at the merchants.

9. The operation system of claim 1 wherein the display contents of the initial screen are determined depending upon the fields of interest stored at the profile of the relevant consumers.

10. The operation system of claim 9 wherein the process of displaying the initial screen comprises the steps of:
making access to the homepage of the exhibition site through driving the Internet browser at the consumer;
logging in to the exhibition site at the consumer by giving ID and password;
checking and examining the profile of the logged-in consumer;
judging whether the value of user preference is present at the profile of the consumer;
displaying a basic web page at the display screen if the value of user preference is absent;
judging whether the consumer selects the definition of the initial screen;
conducting the works of searching, etc. pursuant to the commands of the consumer if the consumer does not select the definition of the initial screen;
conducting the work of defining the initial screen for the consumer if the consumer selects the definition of the initial screen;
storing the initial screen defined for the consumer as “ID.htm”, defining the value of user preference to be 1, and displaying the newly defined initial screen;
judging whether the consumer inputs the command of logging out;
either conducting other normal works if the command of logging out is not input, or conducting the work of logging out if the command of logging out is input;
terminating the access to the exhibition site if the work of logging out is conducted; and
calling upon the “ID.htm” defined for the consumer if the value of user preference is present at the step of judging whether the value of user preference is present, and displaying the “ID.htm” at the initial screen while being followed by the step of judging whether the consumer selects the definition of the initial screen.

11. The operation system of claim 1 wherein the initial screen is displayed with the logging in of the consumer while being linked to the relevant page of the sites of interest stored at the profile.

12. The operation system of claim 11 wherein the process of displaying the initial screen while being linked to the sites stored at the profile comprises the steps of:
making access to the homepage of the exhibition site through driving the Internet browser at the consumer;
logging in to the exhibition site at the consumer by giving ID and password;
checking and examining the profile of the logged-in consumer;
judging whether the direct address of directly making access to the link sites with the logging-in is present at the profile of the consumer;
displaying a basic address at the initial screen if the direct address is absent;
judging whether the consumer inputs the command of writing or editing the direct address;
conducting the works of searching, etc. pursuant to the commands of the consumer if the consumer does not select the definition of the direct address;
judging whether the consumer inputs the command of logging out;
either conducting other normal works if the command of logging out is not input, or conducting the work of logging out if the command of logging out is input;
terminating the access to the exhibition site if the work of logging out is conducted;
displaying the direct address at the initial screen if the direct address is present at the step of judging whether the direct address is present while being followed by the step of judging whether the consumer inputs the command of writing or editing the direct address;
conducting the work of defining the direct address if the consumer selects the definition of the direct address; and
storing the direct address defined for the consumer, defining the value of the direct address to be 1, and displaying the newly defined direct address at the initial screen while being followed by the step of judging whether the consumer inputs the command of writing or editing the direct address.

13. The operation system of claim 1 wherein public competitive bids are made through the steps of:
requesting estimates of the items to be purchased at the consumer;
sending electronic mails of informing the estimate request of the consumer to the relevant merchants;
sending the estimates to the server before the predetermined time at the merchants in a secret manner; and
publicizing the received estimates at the server on the predetermined time, or sending the estimates to the estimate-requesting consumer and to the applied merchants.

14. The operation system of claim 13 wherein the, process of making the public competitive bids comprises the steps of:
making access to the homepage of the exhibition site through driving the Internet browser at the consumer;
logging in to the exhibition site at the consumer by giving ID and password;
writing an electronic mail of requesting estimates of the items to be purchased at the consumer, and sending the electronic mail to the server;
extracting the relevant merchants from the electronic mail address book of the merchants at the server, and sending electronic mails of informing the estimate-request of the consumer to the relevant merchants;
receiving the electronic mails at the merchants;
writing the estimates in a code form at the merchants, and sending the estimates to the server;
receiving and storing the estimates at the server;
sending the received estimates to the purchase-requesting consumer and to the applied merchants at the server;
sending a decoder key of the electronic mail server to the purchase-requesting consumer and to the applied merchants directly after the time appointed for the bidding passes by;
sending a decoder key of the respective merchants to the purchase-requesting consumer and to the applied merchants directly after the time appointed for the bidding passes by;
sending the received decoder keys of the applied merchants to the purchase-requesting consumer and to the applied merchants at the electronic mail server; and
decoding the estimates, and establishing a successful bidder.
